(19) United States
(12) Patent Application Publication
(10) Pub. No.: US 2007/0136133 A1
(43) Pub. Date: Jun. 14, 2007

(54) Digital Signage Transaction and Delivery Methods

(76) Inventor: Yvonne Li, San Jose, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/609,022

(22) Filed: Dec. 11, 2006

Related U.S. Application Data
(60) Provisional application No. 60/749,427, filed on Dec. 12, 2005.

(51) Int. Cl. G07G 1/14; G06Q 30/00; G06Q 40/00

(52) U.S. Cl. 705/14; 705/37

(57) ABSTRACT

Methods for providing digital signage advertisements for display in retail locations are described. In an embodiment, the method comprises facilitating an on-line transaction for digital signage advertisement space in a retail location, receiving a digital signage advertisement responsive to the on-line transaction, and providing over an electronic network the digital signage advertisement for display in the retail location. Pricing data on past digital signage advertisement transactions may be provided for determining a price to be charged for the digital signage advertisement space. The advertisement may be provided over a network to a satellite, simulcast, or narrowcast server to be broadcast to a display system in the retail location.

### CROSS REFERENCE TO RELATED APPLICATIONS

This application claims the benefit of U.S. Provisional Patent Application No. 60/749,427, filed Dec. 12, 2005, which is incorporated by reference in its entirety; this application is related to U.S. Provisional Patent Application No. 60/741,032, filed Nov. 30, 2005, which is incorporated by reference in its entirety

### BACKGROUND

1. Field of the Invention

This invention relates generally to digital signage and specifically to an automated method of facilitating a digital signage transaction and providing a digital signage advertisement for display in a retail location.

2. Background of the Invention

Many retailers have begun to use digital signage advertising to inform potential customers about their products and services. The advertising content can be in the form of on-screen advertisements, infomercials, TV programs, or a combination of advertising forms, which are played on display screens within retail locations. Visitors are exposed to the digital signage advertisements in a non-intrusive way during idle time, for example, while waiting in line.

Digital signage has a number of advantages over traditional advertising media. Businesses can better target their advertisements through digital signage than through mass media such as print ads or television advertising. Local businesses such as doctors, lawyers, accountants, restaurants, boutiques, coffee shops, bookstores and movie theaters are seeking the same local customers, for example. A majority of customers who visit such establishments either work or live in the area and are likely to seek other services and entertainments in the same neighborhood. By placing ads on digital signage screens in nearby stores, local businesses can gain exposure to their likely customers.

Digital signage advertising can also be more cost-effective than traditional advertising. Digital advertisements are often cheaper to generate, and can be used to display unlimited content, as opposed to paper advertising. Storeowners can avoid paying to advertise in local newspapers and magazines, and may be able to offset the price of digital signage advertising by selling ad space on their own in-store digital signage screens.

Despites these benefits, digital signage advertisement sales, creation, and delivery systems are still in their infancy, with multiple steps still performed manually. Negotiations for advertisement space are generally carried out by sales people, for example. Ad content creation and delivery are typically done manually or semi-manually. Once advertisements are made, they are generally burned to DVD and hand-loaded into a DVD player at the retail display location. As such, there is no single solution available for handling multiple aspects of digital signage advertising including ad creation, transaction, routing, distribution, and ad valuation.

Thus, there is a need for a way to automate aspects of digital signage advertising system, particularly the trading, creation, and delivery of digital advertisements.

### SUMMARY OF THE INVENTION

The above need is met by methods for automating aspects of digital signage systems. In an embodiment, a digital signage advertisement is provided for display in a retail location. The method comprises facilitating an on-line transaction for digital signage advertisement space in a retail location, receiving a digital signage advertisement responsive to the on-line transaction, and providing over an electronic network the digital signage advertisement for display in the retail location.

In another embodiment, a price for a digital signage advertisement is automatically determined. The method comprises receiving through a network a valuation input for the digital signage advertisement, calculating a price for the digital signage advertisement based on the input, and offering a digital signage advertisement at the calculated price.

In another embodiment, a utility converts a computer into a digital signage system. The utility comprises a batch file configured to launch a browser upon start up of the computer, load on the browser a web-based digital signage application, authenticate the computer to the web-based digital signage server, and retrieve digital advertising content for display on the computer through the web-based digital signage application.

### BRIEF DESCRIPTION OF THE DRAWINGS

FIG. 1 is a high-level diagram of a client-server architecture in which a digital signage method in accordance with an embodiment of the invention can be performed.

FIG. 2 is a flow chart illustrating the steps performed to implement a digital signage advertising transaction in accordance with an embodiment of the invention.

FIGS. 3 through 5 and 6-1 through 6-3 comprise exemplary user interfaces in accordance with embodiments of the invention.

FIG. 7 is a flow chart illustrating steps for determining a digital signage ad price in accordance with an embodiment of the invention.

The figures depict embodiments of the present invention for purposes of illustration only. One skilled in the art will readily recognize from the following description that alternative embodiments of the structures and methods illustrated herein may be employed without departing from the principles of the invention described herein.

### DETAILED DESCRIPTION OF THE PREFERRED EMBODIMENTS

Overview

Embodiments of the present invention are used to automate aspects of the digital signage advertising process. For example, a software based ad-trading platform is provided that enables users to carry out digital signage advertising transactions on-line. The digital ad-trading platform can be offered as a hosted service comprising a web-based application that provides users with the ability to trade digital signage ad space on a digital open market as well as to submit, approve, and distribute content for display.

An exemplary digital signage advertisement transaction process is as follows:
A user (the seller) posts a request for an ad trade on the system.
A user (the buyer) on the system can locate and respond to this request.
The buyer creates and submits advertising content to the seller using utilities provided by the hosted service.
The seller reviews the ad content and either approves or rejects the content.
In the case of an even exchange transaction, the seller also creates and submits ad content for the buyer.
Throughout the process, seller and buyer are free to communicate with each other, for instance negotiating terms in the transaction. All messages sent will be saved and displayed in a transaction case profile.
Once both sides approved the transaction, the ad(s) will be distributed to the target location(s) according to the terms stated in the transaction.
Either the buyer or seller can terminate the transaction at any time. Once the transaction is terminated, the ad(s) will be suspended from further display.
   Embodiments of the invention may be used to support these and other digital signage processes including content scheduling, content submission for the trade, trade notification, term negotiation, ad site valuation, foot traffic monitoring, viewers' response monitoring, tracking of trade cases, trade term enforcement, content aggregation, content distribution and content display.

A utility gathers information about ad locations for the purpose of site valuation, for instance. The utility may estimate the foot traffic of ad sites and the number of viewer responses to ads, as well as provide proof that ads have played at ad locations. Devices such as cameras (including PC cameras), touch screen monitors, and infrared motion sensors can be used to make the measurements. In an embodiment, a digital ad includes SMS messaging information which viewers can use to request additional information, download coupons, and get information on upcoming events. The number of SMS requests can be used to measure the effectiveness of ad sites.

In an embodiment, SMS as well as kiosk inquiries from viewers at the digital signage screen provide an opportunity to create a pay per request business model that helps ad space sellers to generate additional revenues. When a viewer interacts with the digital signage system by either using a touch screen kiosk to further inquire about an ad or using the SMS service provided in the server to download ad information to the viewer's cell phone, the ad, the location, the date and the time are recorded and stored in a database on an digital advertising server. At the end of each billing cycle, the advertiser is billed according to the number of responses to the ad. This method helps advertisers avoid over paying non-performing ad sites. Instead of paying a full amount up front, the advertisers pay according to the effectiveness of the ad site. The same information that helps advertisers identify non-performing sites can also help the owner of ad sites identify non-performing ads that viewers are not interested in.

In accordance with an embodiment of the invention, an advertising trading platform supports a hierarchical account structure that provides varying levels of administrative rights to users. Users can subscribe to more than one account and construct a hierarchical structure to facilitate their work flow within an organization. Each account within the same branch can initiate trades to the display location. The platform uses a relational database to construct a hierarchical relationship with each of the accounts within the group. The branches and nodes form the account structure. Each branch within an account structure terminates at a player account that is equivalent to a physical display location where the digital signage will be displayed. The branch forms a group of users who all have access right to the display location account but with decreasing administrative rights for those who are lower in the branch. Each user can initiate ad trades for display locations below the user's position in the hierarchy. Users who are higher up in the branch can override actions initiated by users who are lower in the branch. This feature is particularly useful in a corporate environment where headquarters can oversee activities that take place in local stores or in local offices who are managing ad content for their clients. Ad trades can be conducted between non-related groups; that is, between partners from different account structures. All information related to a trade is saved in the case profile accessible by both the seller and the buyer. When a playlist or play sequence is being generated for a particular display location, all of the accounts within a branch are iterated over to determine the ads for that location, which may have been sold by multiple members of an organization.

Reference will now be made in detail to several embodiments of the present invention(s), examples of which are illustrated in the accompanying figures. It is noted that wherever practicable, similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

System Architecture

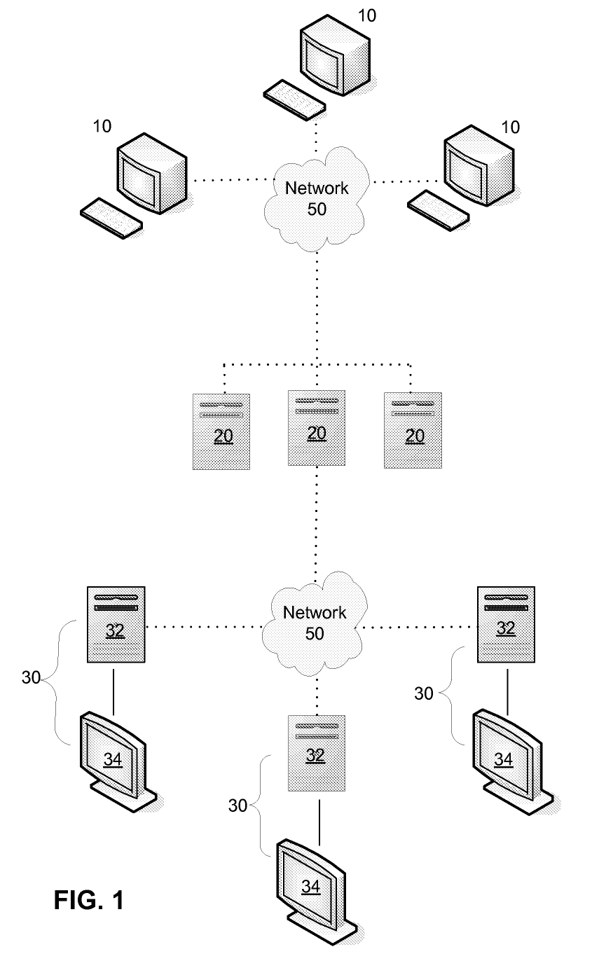

FIG. 1 is a high-level diagram of a client-server system architecture in which digital signage methods in accordance with an embodiment of the invention could be applied. Those of skill in the art will recognize that other embodiments of the invention can operate in different environments than those shown in FIG. 1. Likewise, the functionalities can be distributed among the elements in a manner different than described herein.

The architecture includes one or more digital signage servers 20 coupled through a network 50 to a plurality of client computers 10 and retail display systems 30. The client computers 10 run client-side digital signage management software that can be used to create, approve, and trade advertisements. The retail display systems 30 comprise devices 32 for receiving advertising provided from the servers 20 and displays 34 on which the digital signage ads are broadcast. The servers 20 store end-user applications and user data. The servers 20 administer various aspects of digital signage advertising on behalf of the users, and host advertisements created or provided by users to be served to display system 30.

The client computers 10 and retail display systems 30 are coupled to the servers 20 through a network 50. The network 50 may comprise the Internet, a local area network (LAN) or a wide area network (WAN) operated by an enterprise that may or may not be coupled to the Internet. In addition, the network connection between the client computer 10, server 20, and retail display system 30 may comprise a broadcasting network such as a satellite, cable, narrowcast, simulcast, other transmission network. Ad content may be first provided from a digital signage server 20 over an Internet connection, for example, to a broadcasting server such as a satellite, cable, narrowcast, or simulcast server, from which it is then provided to a retail display system 30.

In one embodiment, the network 50 uses standard communications technologies and/or protocols. Thus, the network 50 can include links using technologies such as Ethernet, 802.11, integrated services digital network (ISDN), digital subscriber line (DSL), asynchronous transfer mode (ATM), and cable technologies. Similarly, the networking protocols used on the network 50 can include multiprotocol label switching (MPLS), the transmission control protocol/Internet protocol (TCP/IP), the User Datagram Protocol (UDP), the hypertext transport protocol (HTTP), the simple mail transfer protocol (SMTP), and the file transfer protocol (FTP). The data exchanged over the network 50 can be represented using technologies and/or formats including the hypertext markup language (HTML), the extensible markup language (XML), the simple object access protocol (SOAP) etc. In addition, all or some of links can be encrypted using conventional encryption technologies such as the secure sockets layer (SSL), Internet Protocol security (IPsec), Secure HTTP and/or virtual private networks (VPNs). In another embodiment, the entities can use custom and/or dedicated data communications technologies instead of, or in addition to, the ones described above.

The client computers 10 are utilized by digital signage buyers, sellers, and administrators associated with various businesses to carry out ad transactions, create ads, and perform other digital signage functions. In one embodiment, a client computer 110 is a typical personal computer such as an IBM-PC or Apple Macintosh compatible computer. In another embodiment, a client computer 10 is another type of networked electronic device, such as a mobile telephone, personal digital assistant (PDA), portable communication device, or Blackberry or other handheld email device. The client computers 10 run software for managing digital signage advertisements. In an embodiment, the software is web-based and no software installation is required on the client computers 10. Instead, an Internet browser is used to run web based applications provided by the server 20. The applications are accessed when a user types in designated URL addresses.

Each retail display system 30 comprises a display 34 on which digital signage advertisements may be played in a retail location. As used herein, the terms “retail location” includes any public or semi-public place in which goods or services may be sold or advertised. The displays 34 may comprise plasma display panels, liquid crystal displays, high-definition screens, computer monitors and television screens capable of delivering full-screen, full-color content similar to ads seen on syndicated TV networks. The displays 34 may also comprise informational kiosk screens placed in “common spaces” within retail locations such as building lobbies or atriums, hallways, throughfares, or waiting areas. Advertising content may be received by an electronic device 32 such as a computer, TV, cablehead, digital video recorder (DVR), or other device for receiving or storing digital content, then broadcast on a display 34 coupled to the device 32.

In an embodiment, the display system 30 comprises software for displaying digital ads hosted by the server 20 and provided to the display system 30 through the Internet. The software may be distributed in a ‘software as a service’ (SaaS) application, enabling a high level of data portability. For example, a digital signage screen may be running continuously throughout the day on a display system 30. With SaaS, a user can remotely change the content without interrupting the display from a client 10 or other computer connected to the Internet. This makes it possible for a central headquarters to deliver and control the content of each of its digital signage displays installed in their local stores. The content can be tested before being distributed through SaaS to the display system 30, for example. Using the client-server architecture as described to serve ads to display systems 30 saves time and labor that would otherwise need to be spent setting up individual networks. Because applications are web-based, software installation and maintenance costs, on the client computer 10 and/or the display system 30, may be avoided.

One or more servers 20 is used to host digital signage applications, store user data, and/or serve requested applications, information and/or advertisements to client computers 10 or digital display systems 30. In an embodiment, a server 20 comprises a personal computer with an Intel, IBM, Sun or other processor. The computer 20 comprises a memory, for example, firmware, read-only memory (ROM), non-volatile random access memory (NVRAM), and/or RAM that holds instructions and data used by the processor.

In an embodiment, a complex relational database is hosted on a server 20 and used to store information including user account profile, display location profile, screen layout, content data, image and text transition effects, foot traffic data, viewers' responses to ad, ad exchange case (transaction) profile and/or aggregated content distribution data. Within the database, tables are setup to optimize the efficiency of data read out. The design of the database structure allows for the implementation of many distinct software features in the ad trading platform. These features include a hierarchical account structure with levels of administrative rights, content aggregation from multiple accounts within a branch, one-to-many ad trading structure, fully automated content routing, fully automated content distribution and display, automatic detection of content updates and/or viewers' response tracking.

In the system shown in FIG. 1, the client computers 10, digital signage servers 20, and display systems 30 all comprise separate and distinct elements. However, it is not necessary for the elements to be housed as shown; the elements can be hosted by other entities or in sub-modules of the elements may stand-alone or together. In some implementations of the system, the various elements may also appear in different configurations. For instance, the client computer 10 and display systems 30 may be at the same or different locations, and comprise shared or distinct elements.

Ad Transaction Platform

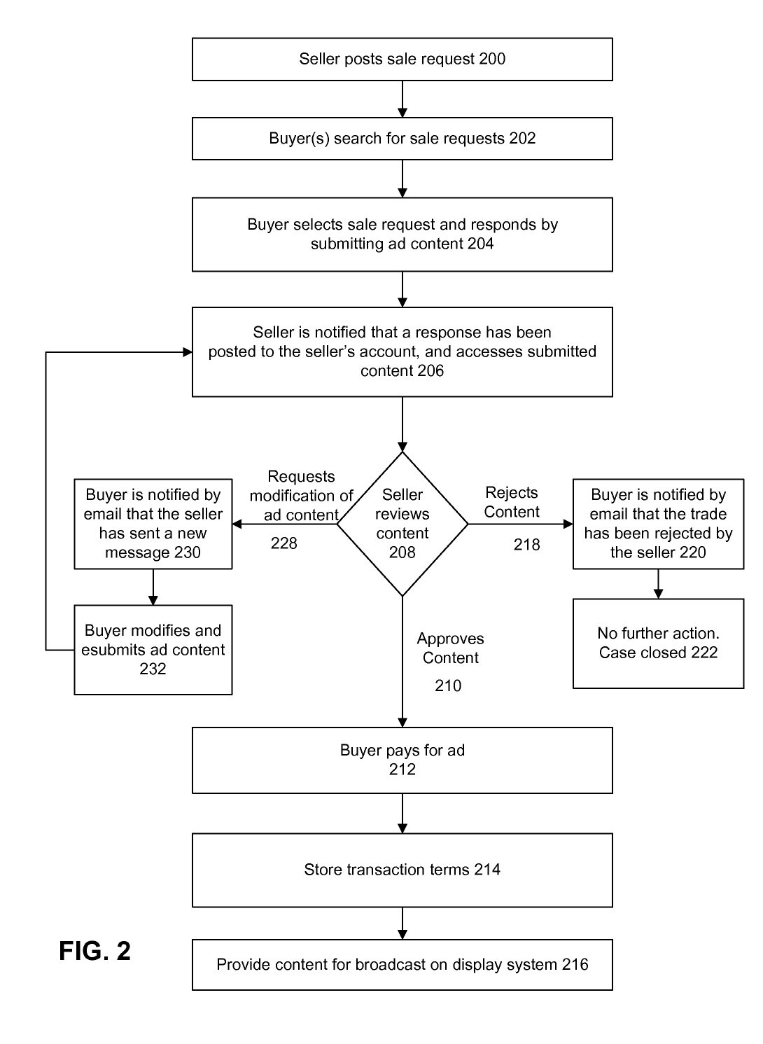

Within the client-server architecture described above, users can carry out a variety of transactions for digital signage advertising space using embodiments of the invention. FIG. 2 is a flow chart illustrating the steps performed to implement a digital signage advertising transaction in accordance with an embodiment of the invention. The ad trading platform is hosted on a digital signage server 20 and provided to users of client computers 10 based on a one-to-many case structure. This means that a user (the seller) only needs to post an ad space sale request once and multiple users (the buyers) can respond to the same request creating multiple trade cases. The seller has the option of choosing the transaction type when posting the request. The transaction may comprise a fixed price, negotiable price, auction, or even exchange transaction. Once a buyer responds to a sale request, a new case profile will be generated with information on both the buyer and the seller along with the trade terms posted on the sale request. Both the buyer and the seller can review the case profile from their perspective accounts. Information on each trade case includes contact information, submitted content, message logs, negotiated price, trade terms and status of the case are stored in a database on a server 20. Users are notified by emails whenever a response is posted to their accounts from another user.

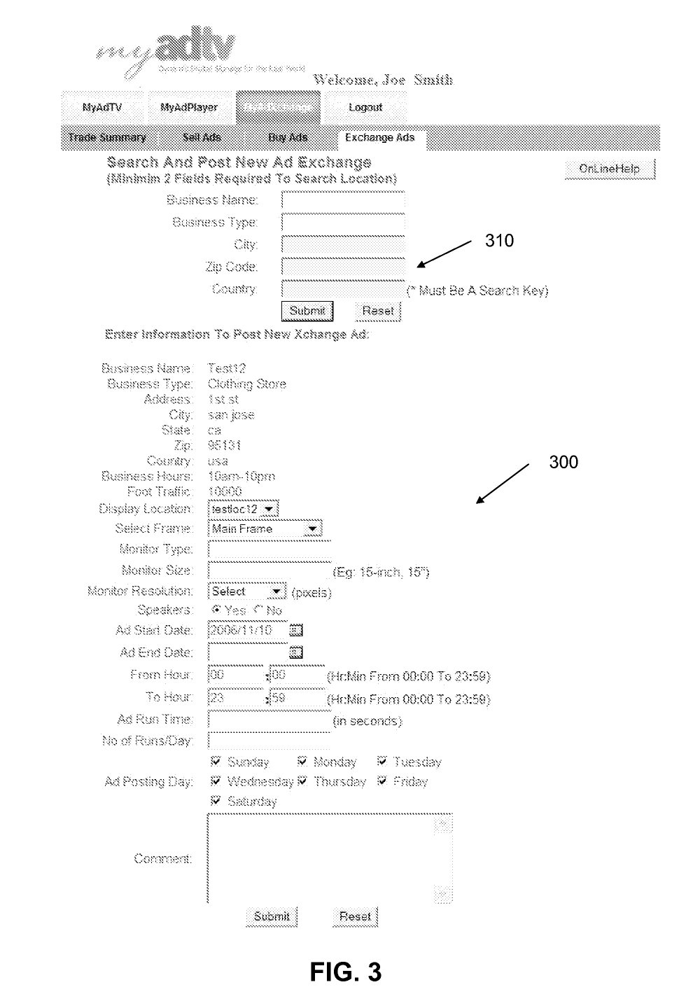

As shown in FIG. 2, the process begins when a seller posts 200 a sales request from his account. The request may be posted 200 using a user interface 300 such as the one shown in FIG. 3. Included in the request is the advertising space that is the subject of the request, and which, in an embodiment, is associated with a player account. As each player account corresponds to a digital signage system physically placed in a location, it is associated with various formatting requirements. In an embodiment, each player account is also associated with a display template that incorporates these formatting requirements. The display template governs the screen layout of the retail location, wherein, for instance, multiple frames may be used to partition the screen into different display areas. Each display area has its own play sequence. At the time of posting, the seller declares which frame is for sale. The information of the display template and the frame is tied to a new sale case. Within the posted 200 sale request, the seller also has to designate the transaction type in terms of fixed price, negotiable price, auction and even exchange from the sale request form. In an embodiment, only one type of sale can be entered at a time. Appropriate pricing information is included in the sales request. In the case of a fixed price transaction, for instance, the seller also posts 200 the price of the ad. In an auction or negotiable price exchange, a starting price or desired range may be provided. In an embodiment, pricing is based wholly or partially on performance of the digital advertisement, for instance using a metric such as foot traffic, or responses to the ad such as the number of clicks at an ad kiosk or the number of requests for additional information made in accordance with instructions provided in a digital signage ad. A seller in a fixed price transaction, for instance, may designate a fixed price per SMS request made based on SMS information provided in a digital ad. Once a user has identified a requested transaction as an even exchange transaction, no additional pricing information is required.

Once a seller posts a sales request in his or her account, the request will be in the trading system until cancelled. Potential buyers can search 202 for advertisement sales requests. In an embodiment, users may search using a search interface 310 such as the one shown in FIG. 3. The interface 310 allows ad requests to be searched by various fields including business name, type, or geography. Any sales requests that match the search criteria will be provided to the searching buyer. After a buyer selects 204 a sales request, a case profile that contains information about both the seller and the buyer is generated.

In the case of an auction transaction, assuming the buyer decides to participate in the auction, the buyer submits a bid according to the auction parameters, which can specify a base price, bidding period, and minimum bidding increments. The buyer must submit a price that is equal or higher than the base price. The seller will set the auction end date. Once the auction has ended, the seller can choose the winners of the bid. In an embodiment, multiple bidders can win in an auction. For instance, if the seller wants to sell 5 ad slots and there are 10 bidders, the seller can pick the top 5 bidders as the winners of the bid. Once the seller pick the winners, a trade case profile will be generated for each of the winning bids, in this example, there would be 5 case profiles generated. After the winning bid(s) is chosen, the buyer(s) respond by creating 204 and submitting 204 ad content to the seller

The process is simpler for negotiable price, fixed price, and ad exchange transactions. In the case of a negotiable price transaction, the buyer responds to an ad request by creating 204 and submitting 204 ad content, as well as a proposed price to a potential seller. To carry out price negotiations, the buyer and the seller can communicate via a messaging utility, such as an instant messaging program, provided in case profile page. All messages are logged and displayed on the page so that both the buyer and the seller can keep track on the progress of the negotiation. In the case of an ad exchange transaction, the buyer provides an ad slot to be exchanged in place of the proposed price. The buyer may also ask for the seller to submit an ad to be used in the buyer's retail location. In the case of a fixed price transaction, the buyer does not need to supply a price term.

Once the price term has been agreed upon, through one of the four methods described above, the buyer submits 204 an ad to the seller for approval. When the buyer submits 204 an ad from his or her user account, the software first searches in the buyer's content inventory to locate any ads with the format that match the target frame to be sold. If there are ads that match the target frame, the buyer has the option of submitting 204 an existing ad or creating a new ad for this sale case. If there is none found, the buyer must create a new ad and then submit 204 it to the seller for approval. In an embodiment, an ad creation utility is provided to the buyer that retrieves target frame information such as the relevant media types and frame sizes. The utility uses this information to create a template that the buyer can use to create a new ad. The new ad is then tied to the trade case and the buyer submits the 204 ad for the seller to approve.

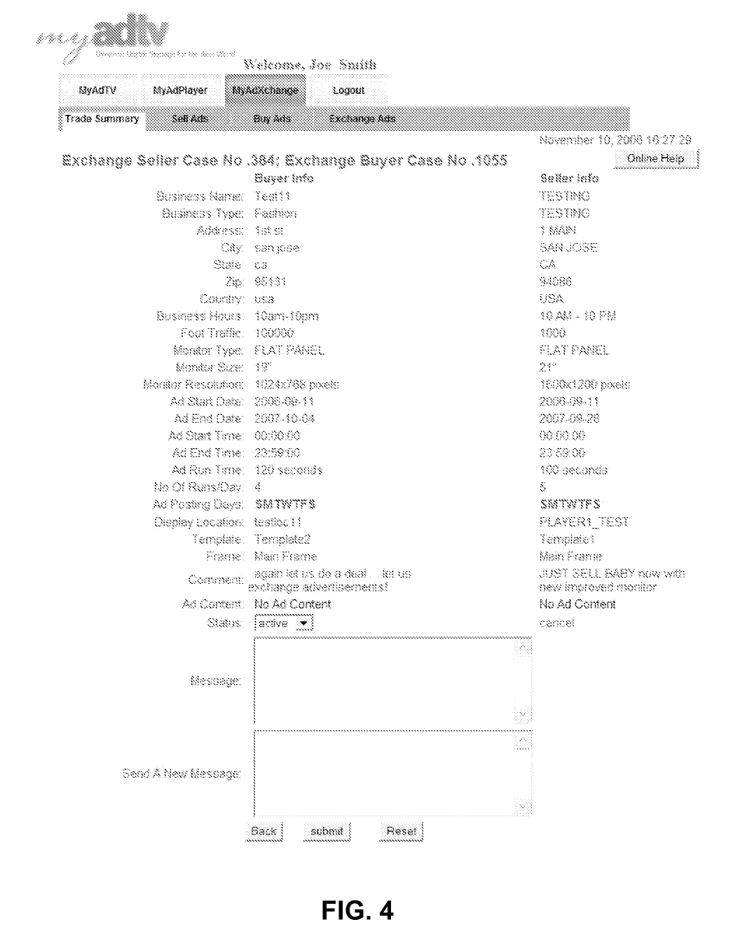

In each of these four cases, the seller is notified 206 by email that a response and ad content have been posted to his request. A case profile may be created and used to identify any communications between the seller and buyer about the ad transaction, as shown in FIG. 4. The seller logs in to his account to access 206 the submitted content. After reviewing 208 the content, the seller can take one of three steps: reject 218 the ad content outright, request 228 modification of the content, or 210 approve the content. If the content has been rejected 218 by the seller, for instance because it does not conform to the seller's retail image or display policies, the buyer is notified 220 that the proposed transaction has been rejected and the case is closed 222. If the seller requests 228 modification, on the other hand, the buyer is notified 230 of the request and can modify 232 and resubmit 232 ad content to the seller for another review 208 iteration.

At the time of approval, a check is performed to ensure there is enough ad time available in the designated player account to accommodate the sale according to the trade terms. If there is not enough ad time, the software will prevent the seller from approving the ad and inform the seller that no more ad time is available. At this point, the seller must delete some of the existing ads in order to make room for this new sale. If not, the sale will not go through. Once the check has been successfully peformed and the buyer's content has been approved 210 by the seller, the buyer pays 212 the agreed amount in an embodiment through an integrated payment system. The system may comprise a connection to a credit card or payment server. The ad content, transaction terms, and display details are stored 214 in a database at the digital signage server 20. If the trade is an even exchange, the payment step is skipped 212, however, prior to storing 214 and providing 216 the buyer's ad content, the seller must also submit an ad to the buyer for approval. Only when both the seller and buyer approve the ads will the even exchange transaction be considered “active.”

In certain embodiments of the invention, both the buyer and the seller can terminate the transaction at any time. Once terminated, any ads associated with the case will be suspended from playing on the digital signage screens. This may be accomplished by eliminating the ads from a playlist or play sequence on one or more retail display systems 30. In an embodiment, the terms governing termination are listed in a user licensing agreement that all users must agree to governing before they can use the ad tracking system.

Ad Distribution and Display

Once an ad has been agreed upon and paid 212 for, whether in the form of cash or an ad exchange, and the transaction terms are stored 214, the ad is provided 216 from the digital signage server 20 to be broadcast on a display system 30 at the retail location for which the ad has been purchased. In an embodiment, the ad is provided 216 in the form of ad content over the internet in response to an HTTP request provided from the display system 30. The display system 30 regularly polls the server 20 for status and content updates. In another embodiment, the ad is provided 216 to an intermediate server, such as a satellite or cable server, before it is then provided, over a local network for instance, to the appropriate display system 30.

Since the data and the media files are stored on a remote central server 20, content can be played back at any location on any display system 30 connected to the network 50. In an embodiment, when playing back the content, a web-based application running on the display system 30 downloads data from the server 20 to compile a playlist or play sequence. The data is placed in a memory of the display system 30. After the entire list is played, the application goes back to the server 20 and sees if there are any updates since the last access. If there are any updates, the software will compile a new list. If there are none, the application will play the content from memory. Users can log-in to their user accounts remotely and make changes to the ads playing or insert new ads to that location. Any data can be edited and updated to a display system 30 playing content. To viewers, the content plays continuously and updated are integrated into the next play cycle without interruption.

Transaction Enforcement

An ad transaction will generally specify price and performance terms. In an embodiment of the invention, an ad trading platform as described above also includes utilities for enforcing these terms. In the process described in FIG. 2, payment by a buyer is required before the ad is played. However, once a payment has been made, a utility can also be used to ensure compliance with the performance terms of an ad transaction, including confirming that the digital signage ad has been displayed as agreed upon. For instance, a PC camera can be used to take images of a display screen to provide proof of an ad being played at the seller's digital signage screen. Each time an ad is played, the PC camera will capture a low resolution image which will be sent to the digital signage server 20 and stored in a database. This image is tied to the case profile and can be viewed by the buyer from the case profile page. The image will be tagged with the date and time when it is taken. This serves as an enforcement of the performance terms of a trade agreement. The buyer also has the convenience of monitoring the trade from anywhere and anytime.

One-Click Turnkey System

In an embodiment, to initiate a content play back on a display system 30 comprising a PC, the user enters a designated URL address, the player account login name and the password, into a command line in a browser running on the PC. The display system 30 runs ad player software that uses a combination of html code, JavaScript, php and flash to play back ad content. Ad player software on the server 20 receives the request and validates the account name and password using database information. Then it seeks information regarding the player account such as the file name of the template, the layout of the display, and whether or not the display is currently showing digital signage ads. Recall that, as described earlier, a player account may be part of a hierarchy of user accounts that is organized into individual branches. In an embodiment, the application retrieves content for the player account from all user accounts that belong to the same branch as the player account using an iterative process as described earlier. Separate lists of content are compiled for each frame on a display. All content lists are played simultaneously on the screen.

In an embodiment, a utility button is provided within the user account that places on a computer of the display system 30 a batch file that will initiate an Internet browser with the content playback URL. The batch file is placed in the Start Menu folder on the computer. The content playback starts automatically without any user input when the computer is first powered on. With this batch file, a computer is converted into a turnkey digital signage system via a ‘one-click turnkey’ feature. The utility can control playback in any of a variety of ways. In an embodiment, the ad content is streamed and played in semi-real-time on the display system 30 of the retail location. In another, one or more advertisements is cached locally on the client computer, and played according to the advertisement play sequence.

Play Sequence Generation

A playlist or play sequence may be generated at a server 20 or a display system 30. In an embodiment, a playlist is generated by gathering all the active ads that are scheduled to be played at the time the list is compiled. Each ad has a start and end date, start and end time, day(s) of the week, and ad duration. For example, a 60-second ad could be scheduled to play everyday during the month of November, 20 times a day, between 9 am and 5 pm. When compiling a play sequence, the software detects the current time from the display system 30 and checks again the ad schedule and the number of times the ad has been played that day. In this example, the date must be on or after November 1 and before or on November 30, after 9 am and before 5 pm. The database records the number of times that ad has been played on that day, if it hasn't reached 20 times yet, the ad will be included in the list. After the entire list is played, the software will repeat the process, checking the ad schedule against the current date and time and the number of time it has played.

Ad Creation Application

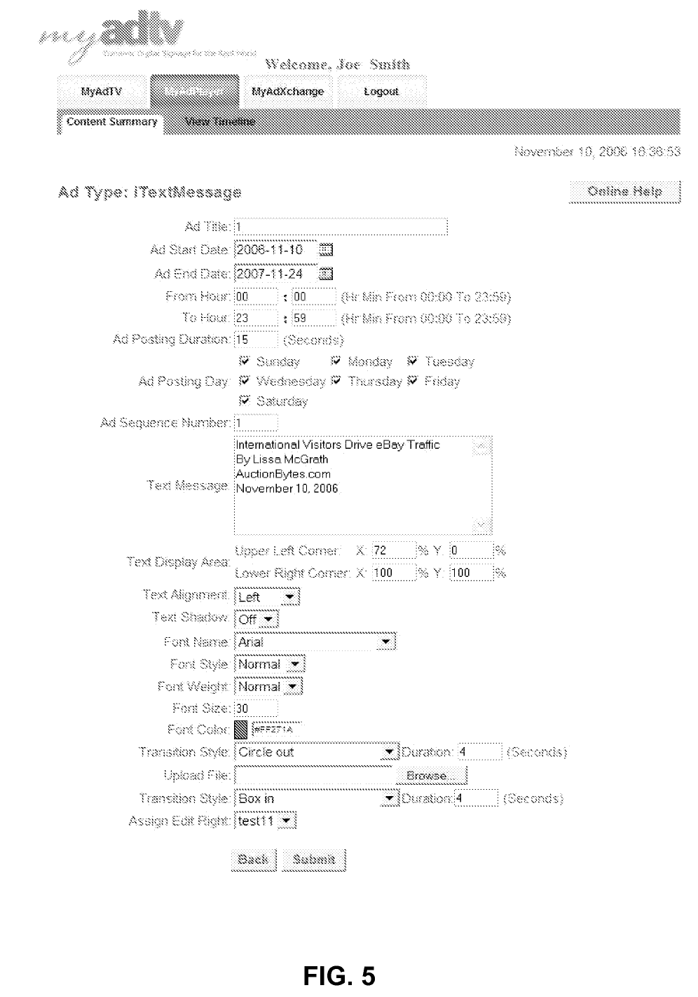

As described earlier, an ad trading platform can include an application for the creation of digital signage advertisements. Exemplary user interfaces of one such application are provided at FIGS. 5 and 6-1 through 6-3. A user can use the application to create advertisements for display on the user's own digital signage display systems 30 or those of the partners with which the user has transacted. To create an ad, the user fills in a simple form providing the necessary information to run the ad and uploads the media file to be used in the ad. In an embodiment, the ad creation application accepts three different types of files including graphics, animation (such as flash animation), and movie files, which are integrated into the final digital signage ad. File formats include jpeg and gif for graphics, swf for animation, and wmv, avi, mov and mpeg for movies. The user provides information such as the ad title, ad start date, ad end date, ad start time, ad end time, ad duration, ad sequence, and ad transition style. When the ad is for an already purchased ad space, the information is supplied in accordance with the advertising transaction.

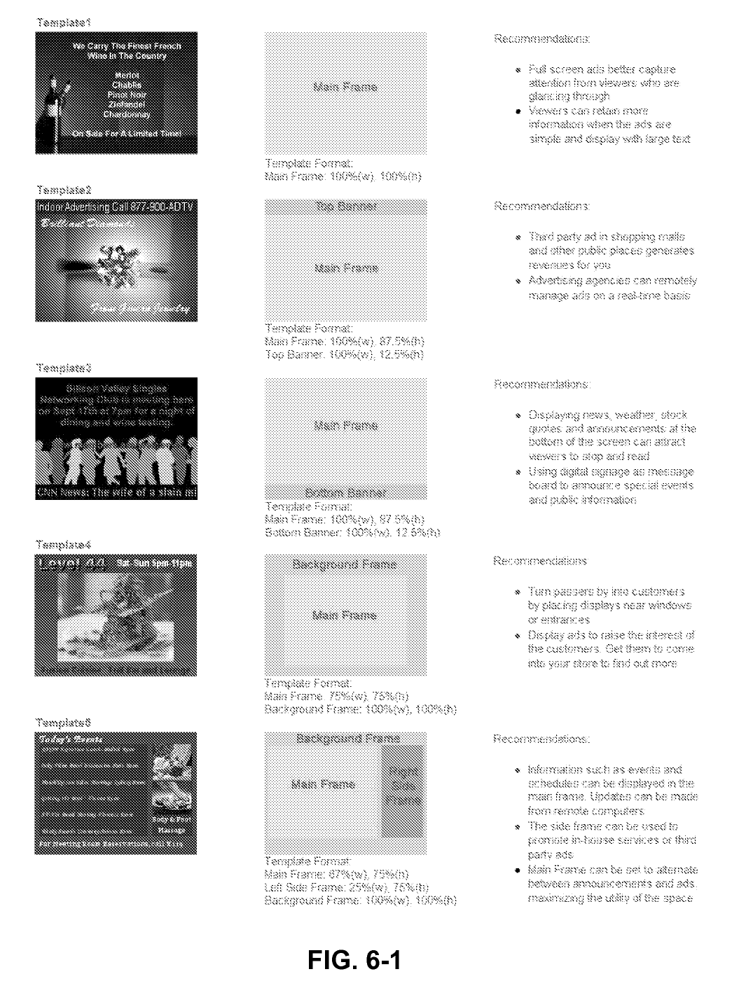

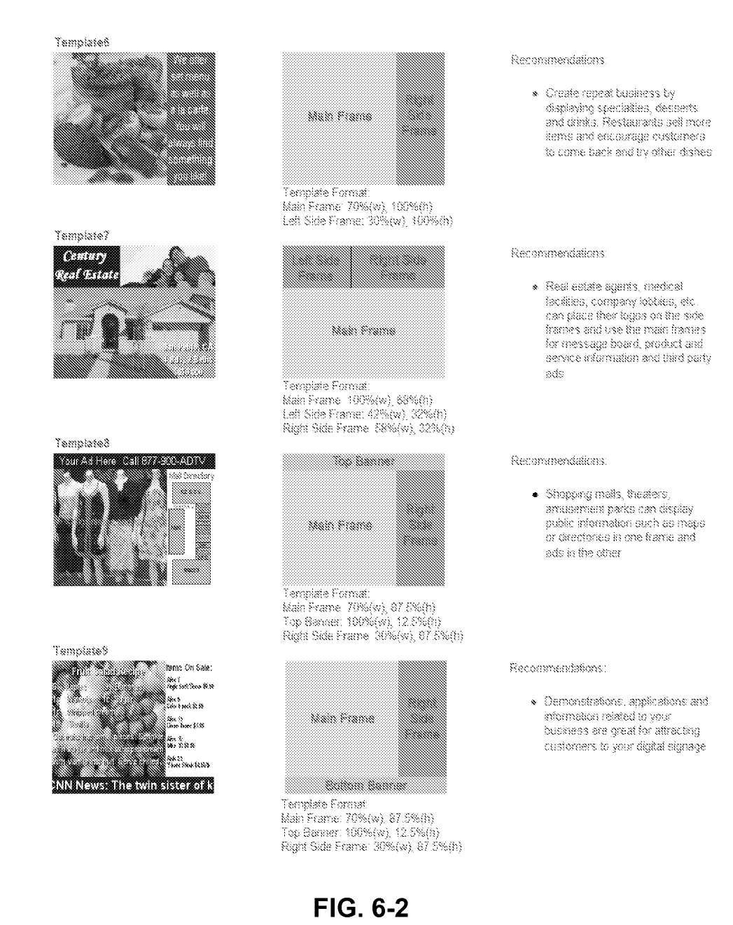

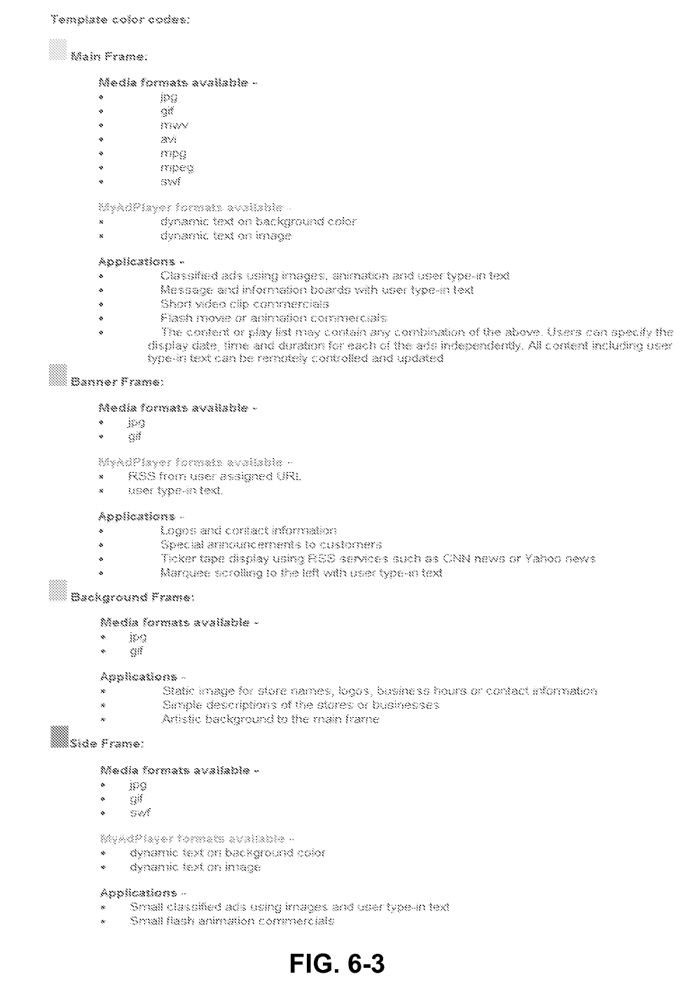

As shown in FIG. 6, an ad creation application may include ad templates, ad portions especially formatted for digital signage advertisements, and other tools to help users create digital ads. The application also accepts user text to be overlaid on the static image. The user can specify the font name, type, style, size, color, transition style and the placement of the text. The text content is displayed as ad message on the digital signage screen. An advantage of using overlaid text is the ease of changing the ad message. Simple changes can be implemented quickly and updated automatically to the digital display screen 32.

Ad Valuation

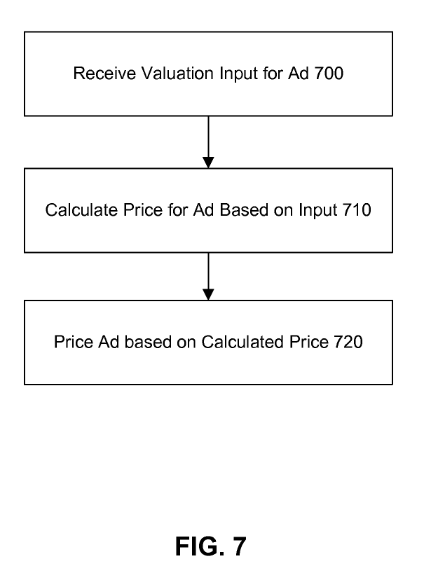

As described earlier, in embodiments of the invention, ads may be offered under various pricing schemes. When a seller first post a request to sell an ad space, he has to determine a base price for the transaction, whether the sale is an auction, fixed-price, or negotiable-price transaction. The flowchart in FIG. 7 illustrates one method for determining a price for a digital signage advertisement.

In the initial step of the method, a valuation input is received 700 for the ad. In an embodiment, this valuation input is in the form of an average price of comparable past digital signage transactions. Data on past and present digital signage transactions are stored within a central server. The seller can find comparable prices by typing in search criteria such as a zip code or city, foot traffic of the store, the size of the display monitor and/or the business type. The software will look in the server for ads that match the criteria and calculate an average price that advertisers paid in the past. This serves as an input upon which a price for the proposed ad can be automatically calculated 710. In an embodiment, the ad is then priced 720 using this calculated price.

Other potential valuation inputs include foot traffic of the ad location, the number of viewer responses to the ads, the type of business of the retail location, and the demographic makeup of the location. These inputs can be collected using various methods. For instance, foot traffic can be measured by detecting the number of people that pass by a digital signage screen during a given time period. It is understood that not everyone will stop at the signage screen and view the ads. In the most likely scenario, a customer walking past a digital signage screen glances at the screen for a second or two. If the ad catches the customer's interest, he or she will stop and read further. In this way, foot traffic provides a measure of ad effectiveness.

In an embodiment, an off-the-shelf sensor is used to measure foot traffic at a retail location. Two technologies that could be used for sensing are thermal imaging and infrared beam detection. The sensors detect the number of people walking past the digital signage screen and send the data to a local computer in the retail location. In an embodiment, a server is part of the display system 30 described above. Data from the sensor can be sent using wireless transmission or a cable connected directly to the computer's USB data port. The data is then uploaded from the computer to the central servers 20 over a network 50. The data is then stored in a database that will be used for the valuation of the ad site in the future.

Another valuation input comprises a user input provided at a kiosk for displaying the digital signage advertisement. In an embodiment, the input comprises a selection provided by a user on a touch-screen or using a pointing device such as a mouse or a track ball. The kiosk software is programmed to redirect the screen to another URL address that contains further information about the ad. The kiosk computer will switch back to the digital signage screen and continue to play the ad content when there is no user input after a period of time. When a viewer interacts with the kiosk, the computer will send information to a digital signage server 20 over a network 50 regarding what ad the viewer is interested in, what information the viewer is acquiring, the kiosk location, the time, and the date. The information is stored in the database and is later used to calculate 710 a price for an ad.

In another embodiment, the valuation input comprises requests for information provided through text messaging requests. In an embodiment, a digital signage ad is provided that includes a phone number or email address as well as a code name for the product being advertised that a user can contact for further information about the ad. In an embodiment, a digital signage server 20 is coupled to an email or text message server that can regularly check for relevant messages. The server 20 then provides the requested information to the user's cell phone or email device. The server records the ad, location, time and date of the request and store them in the database for valuation purposes.

Once the valuation input has been received 700, prices can be calculated 710 for digital advertisements. The prices may be calculated according to statistical techniques that consider one or more factors including (i) the type of ads that viewers are acquiring information at that location which ties to demography; (ii) the time and day that viewers acquiring more ad information which helps to determine the price structure; (iii) the frequency of viewers acquiring an ad information which measures the effectiveness of an ad; an (iv) the ratio between foot traffic and information acquisition (including, for instance, size of display monitor and viewing conditions), which measures the effectiveness of the digital signage placement within a facility. This information can be analyzed to generate an index on how much advertisers should pay for an ad space in a particular location including for a particular day at a particular time. Another valuation input may comprise relative results regarding what types of ads gets better results in a particular location. Since advertisers list their business type in the user profile, the business type can also be used as part of the statistical analysis. The results of the statistical analysis can be shown in different formats such as weighted averages or graphs. Data collected from the sensors and the interactive functions at various locations can be placed into a valuation database thus supplying a resource of multiple users.

A historical record comprising such valuation data can also be used to improve the ad transaction process. Using a search utility, for instance, an advertiser can search a location that posted an ad space sale request by entering information such as zip code, type of business and price range. The advertiser can choose to view the seller's information from a list of posted requests that match the search criteria. The seller's information can include store foot traffic, average number of responses from viewers, day and hours of peak response frequency and type of ads versus response frequency. This information will help advertisers to determine if the display location is right for the type of ads they are placing. The advertisers also can check on the average price of ads in the area and use that as a price index.

In an embodiment, ad sellers are compensated based on a “pay per request” basis, as described earlier. Under such a model, the sellers may detect and record viewer interactions with kiosks, SMS programs, or other digital signage systems. When a viewer requests ad information either from the kiosk touch screen or by sending a text message to the system, information identifying the ad, the display location, the date and the time are recorded in the database. At the end of each billing cycle, the advertiser posting the ad will be billed according to the number of requests from the viewers. In embodiments of this invention, the ad trading platform is capable of supporting the rotation of ads among ad sites. An account structure may include multiple player accounts corresponding to multiple display locations. The owner of a player account may have multiple digital signage screens physically installed in the same facility or in different facilities. In either case, if the owner wishes, he can offer the advertisers the choice to rotate the ads among ad sites that are within the account structure. As an example, if the trade case is a fixed price sales and the number of runs per day is 20, 4 digital signage screens are installed in two different stores, the ad will run 5 times a day in each of the digital signage screens at different period time or at the same period time. At the time the play sequence is generated, the ad-player software will detect the date and time of the display system and read the number of times the ad already ran for the day and the schedule from the server and determine if the ad should be included in a play sequence or not.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above teachings. It is therefore intended that the scope of the invention be limited not by this detailed description, but rather by the claims appended hereto.

What is claimed is:

1. A method for providing a digital signage advertisement for display in a retail location, the method comprising:
facilitating an on-line transaction for digital signage advertisement space in a retail location;
receiving a digital signage advertisement responsive to the on-line transaction; and
providing over an electronic network the digital signage advertisement for display in the retail location.

2. The method of claim 1, wherein the transaction comprises a negotiable-price transaction or an auction-based transaction.

3. The method of claim 1, wherein the transaction comprises a trade of digital signage advertising space.

4. The method of claim 1, wherein facilitating comprises providing pricing data on past digital signage advertisement transactions for determining a price to be charged for the digital signage advertisement space.

5. The method of claim 1, wherein facilitating comprises receiving a plurality of offers to buy or sell digital signage advertisement space, and wherein the method further comprises providing an interface for searching the plurality of offers.

6. The method of claim 1, further comprising providing an application for creating a digital signage advertisement.

7. The method of claim 6, wherein the application is configured to create an advertisement including at least one of: a graphics file, animation, and a movie file.

8. The method of claim 6, wherein the application comprises a template formatted in accordance with the digital signage advertisement space.

9. The method of claim 1, wherein providing comprises providing the advertisement over the internet to a display system in the retail location.

10. The method of claim 1, wherein providing comprises providing the advertisement over a network to a satellite server to be broadcast to a display system in the retail location.

11. The method of claim 1, wherein providing comprises providing the advertisement to a server to be broadcast over a simulcast or narrowcast network to a display system in the retail location.

12. The method of claim 1, wherein providing comprises determining a play sequence of digital signage advertisements for the retail location, and providing the digital signage advertisement responsive to the play sequence.

13. The method of claim 12, further comprising receiving a request to suspend the digital signage advertisement and deleting the digital signage advertisement from the play sequence responsive to the request.

14. The method of claim 1, wherein the advertisement is adapted to be displayed on a kiosk in the retail location.

15. The method of claim 1, further comprising providing the digital signage advertisement for approval and receiving approval of the digital signage advertisement; and wherein providing the digital signage advertisement over the electronic network is performed responsive to the approval.

16. The method of claim 1, further wherein the on-line transaction comprises a plurality of terms, and further comprising receiving data captured at the retail location for enforcing a performance term of the plurality of terms.

17. The method of claim 16, wherein the data comprises images of a digital signage advertisement display in the retail location.

18. The method of claim 1, further comprising storing data about display of the digital signage advertisement in a computer memory, the data comprising foot traffic data or ad response data.

19. The method of claim 18, wherein the ad response data comprises user input at a digital signage advertisement kiosk or a request for additional data made in accordance with instructions provided in the digital signage advertisement.

20. The method of claim 1, wherein, in accordance with the on-line transaction, payment for the digital signage advertisement space is calculated at least in part based on responses to the digital signage advertisement.

21. A method of automatically determining a price for a digital signage advertisement, the method comprising:
receiving through a network a valuation input for the digital signage advertisement;
responsive to the valuation input, calculating a price for the digital signage advertisement; and
offering a digital signage advertisement at the calculated price.

22. The method of claim 21, wherein the digital signage advertisement is associated with a retail location and the valuation input comprises a measurement of foot traffic near a digital signage advertisement display in the retail location.

23. The method of claim 22, wherein the measurement is collected through a thermal imaging sensor or an infrared beam sensor.

24. The method of claim 21, wherein the valuation input is based on user requests for information provided through text messaging requests.

25. The method of claim 21, wherein the valuation input is based on user input provided at a kiosk for displaying the digital signage advertisement.

26. A utility for converting a computer into a digital signage system, the utility comprising a batch file configured to:
launch a browser upon start up of the computer;
load on the browser a web-based digital signage application;
authenticate the computer to the web-based digital signage server; and
retrieve digital advertising content for display on the computer through the web-based digital signage application.

27. The utility of claim 26, wherein the batch file is configured to cache the digital advertising content.

28. The utility of claim 27, wherein the computer is configured to play content streamed from the web-based digital signage server.
